(19) United States
(12) Patent Application Publication
(10) Pub. No.: US 2005/0055293 A1
(43) Pub. Date: Mar. 10, 2005

(54) Methods and systems for offering and servicing financial instruments

(76) Inventors: James R Birle, Summit, NJ (US); Jeffrey N Edwards, Basking Ridge, NJ (US); Yonathan Epelbaum, New York, NY (US); Frederick J Fiddle, Ridgewood, NJ (US); Emerson P Jones, Greenwich, CT (US); Stuart C Kaperst, New York, NY (US); Todd K Kaplan, Winnetka, IL (US); Daniel Y Kerstein, Woodmere, NY (US); Richard P Luciano, Morristown, NJ (US); Thomas H Patrick, New York, NY (US); Paul A Pepe, New York, NY (US); Eric Steifman, New York, NY (US); Russell L Stein, Englewood Cliffs, NJ (US); Brennan J Warble, Bronxville, NY (US); Richard J Green, Woodbury, NY (US)

Correspondence Address: OPPEDAHL AND LARSON LLP, P O BOX 5068, DILLON, CO, 80435-5068, US

(21) Appl. No.: 10/483,343

(22) PCT Filed: Aug. 12, 2002
(86) PCT No.: PCT/US02/25697

Related U.S. Application Data
(60) Provisional application No. 60/311,516, filed on Aug. 10, 2001.

(51) Int. Cl. G06F 17/60

(52) U.S. Cl. 705/35

(57) ABSTRACT

Systems and methods for offering and servicing financial instruments (101) creates a way for issuers to offer financial instruments (101) that are accretive to earnings regardless of the Price/Earnings ratio. Specifically, the present invention provides systems and methods for offering and servicing convertible or exchangeable contingent conversion financial instruments.

### CROSS REFERENCE TO RELATED APPLICATION

This claims the benefit of U.S. Provisional Patent Application No. 60/311,516, filed Aug. 10, 2001, which is hereby incorporated by reference in its entirety.

### BACKGROUND OF THE INVENTION

This invention relates to convertible and exchangeable financial instruments (e.g., debt instruments, preferred instruments, trust preferred instruments, warrants, certain insurance contracts, and suitable derivatives thereof, or any security backed by any of the above) and methods and systems for offering and servicing the same.

A convertible instrument, which may be converted into something of value (e.g., common stock), may be referenced throughout this application. The scope of this invention also includes exchangeable instruments which may be exchanged for something of value. As used herein and in the claims that follow, all references to a convertible instrument, or to conversion apply equally to an exchangeable instrument, or exchange, respectively.

A common financial instrument, for example, is a convertible bond which can be converted by holders into a fixed or formula amount of shares. At issuance, the value of the bond is typically greater than the value of the fixed shares that the bond is convertible into. For example, a bond may be issued for $1,000 with a right to convert into ten shares of the issuer's common stock, at a time when the current market value per share is $83. ordinarily, under these terms, the stock must appreciate to at least $100 per share before it would be economically rational for the holder to exercise its right to convert the bond. A convertible bond of this kind is described as having a roughly 20 percent conversion premium, because the stock must appreciate about 20 percent (i.e. $17) before conversion would be economically advantageous.

Because the conversion right provides an investor with a possible appreciation in value that the fixed rate debt of the issuer does not provide, the interest rate on convertible instruments may be lower than the interest rate on fixed rate instruments. Economically, the conversion right is an option to acquire issuer stock, and the lower rate of interest compensates the issuer for providing this option.

Convertible instruments generally also provide that the issuer may optionally redeem the instrument prior to its stated maturity, subject to the holder's conversion rights. If at the time of the optional redemption the value of the stock has risen above the value of the debt, the holder generally will exercise its conversion right so that it receives the stock rather than the optional redemption amount.

Issuing a convertible financial instrument often proves to have an unfavorable effect on a corporation's Earnings Per Share (“EPS”). It would be desirable to provide financial instruments, and methods and systems for offering and servicing such financial instruments, that provide issuers with a financing that is not initially disadvantageous in the calculations used to derive earnings per share.

### SUMMARY OF THE INVENTION

It is an object of this invention to provide financial instruments, and methods and systems for offering and servicing such financial instruments, that are contingently convertible. In some embodiments, these convertible financial instruments may include zero coupon notes (e.g., long-term zero coupon notes (including Liquid Yield Option™ Notes (“LYONs™”)), cash pay or partial cash pay bonds, debt instruments, floating rate debt instruments, preferred instruments, trust preferred instruments, warrants, certain insurance contracts, suitable derivatives thereof, or any security backed by any of the above). Also, some embodiments may allow the number of underlying instruments issuable or deliverable at conversion or exchange to be variable or adjusted under certain circumstances (e.g., merger, acquisition, or formulae amounts).

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1-4 are flowcharts of illustrative steps involved in issuing and servicing contingently convertible financial instruments in accordance with some embodiments of the present invention;

FIG. 5 presents the illustrative information flow for issuing and servicing financial instruments, in accordance with some embodiments of the present invention;

FIG. 6 is illustrative of an exemplary system for implementing the method in accordance with some embodiments of the present invention;

FIG. 7 is a cross-sectional view of a magnetic data storage medium encoded with a set of machine-executable instructions for performing the method in accordance with the present invention; and

FIG. 8 is a cross-sectional view of an optically readable data storage medium encoded with a set of machine executable instructions for performing the method in accordance with the present invention.

### DETAILED DESCRIPTION OF THE INVENTION

The present invention is a contingently convertible or exchangeable financial instrument, and systems and methods for offering and servicing the same. In accordance with some embodiments, the instruments may be based on, for example, short or long-term (20-30 year) zero coupon instruments (e.g., long-term zero coupon notes (including Liquid Yield Option™ Notes (“LYONs™”))), cash pay or partial cash pay convertible bonds, debt instruments, preferred instruments, trust preferred instruments, warrants, certain insurance contracts, suitable derivatives thereof, or any securities backed by any of the above. The issuer of a contingently convertible instrument may be, for example, a publicly-traded, widely-held company sometimes referred to herein as the issuer of the instrument. The issuer of the financial instrument may allow contingent conversion of the instrument in certain circumstances or under certain formulae calculations.

For example:
1. when the closing sale price of the shares for at least a pre-determined number of trading days prior to the day of exercise is greater than a pre-determined percentage, for example, lower than or greater than 100%, of the conversion price, for example, per common share or such preceding trading day;
2. upon the occurrence of the value of the financial instrument falling below the initial value.
3. when such instruments have been called for redemption;
4. upon the occurrence of certain corporate transactions (e.g., significant distributions to shareholders, mergers, consolidation, etc.);
5. during any period in which the credit rating of the instrument is below a specified level;
6. when the financial instrument is trading at less than, equal to, or greater than a pre-determined value or formulae amounts; or
7. other formulae based on the value of the financial instrument, another financial security, or an index amount of a reference security, or a pool of securities or indices, or both.

The conversion price per common share on a given day may, for example, equal the quotient of the sum of the issue price of the instrument plus any accrued original issue discount for such instrument, divided by the number of shares issuable upon conversion of the instrument on that day.

The number of shares issuable upon conversion of an instrument, in accordance with this invention, may vary by design or be adjusted for certain reasons, such as stock splits, stock dividends, mergers, or consolidation. In some embodiments, the number of shares may not be adjusted for accrued original issue discount.

### EXAMPLE 1

### Calculation of Contingent Conversion Trigger Prices (Part 1/7)

| Assumptions: | | | |
|---|---|---|---|
| Stock Price @ Issue | $100.00 | Yield | 2.00% |
| Initial Conversion | 30% | Face Value at Maturity | $1,000.00 |
| Premium | | | |
| Initial Conversion Price | $130.00 | Issue Price | $671.65 |
| Conversion Ratio | 5.166500000 | True Yield | 1.00% |
| | | (Semi-Annual) | |
| Issue Date | Aug. 13, 2001 | Initial Trigger | 120.00000% |
| | | Decline | 0.12660% |

| | Bond Conversion | | | | | |
|---|---|---|---|---|---|---|
| | Semi-Annual | | | | | |
| | Bond | | | | | |
| | Accreted | | Accreted | | | Trigger |
| Date | Value | Year Fraction | Value | Price | Trigger % | Price |
| Issue Date | | | | | | |
| Aug. 13, 2001 | $671.65 | | | | | |
| Nov. 1, 2001 | | 0.21666666667 | 674.56 | $130.56 | 120.0000% | $156.68 |
| Feb. 1, 2002 | | 0.25000000000 | 677.92 | $131.21 | 119.8734% | $157.29 |
| Feb. 13, 2002 | $678.37 | | | | | |
| May 1, 2002 | | 0.21666666667 | 681.31 | $131.87 | 119.7468% | $157.91 |
| Aug. 1, 2002 | | 0.25000000000 | 684.70 | $132.53 | 119.6202% | $158.53 |
| Aug. 13, 2002 | $685.15 | | | | | |
| Nov. 1, 2002 | | 0.21666666667 | 688.12 | $133.19 | 119.4936% | $159.15 |
| Feb. 1, 2003 | | 0.25000000000 | 691.55 | $133.85 | 119.3670% | $159.77 |
| Feb. 13, 2003 | $692.00 | | | | | |
| May 1, 2003 | | 0.21666666667 | 695.00 | $134.52 | 119.2404% | $160.40 |
| Aug. 1, 2003 | | 0.25000000000 | 698.46 | $135.19 | 119.1138% | $161.03 |
| Aug. 13, 2003 | $698.92 | | | | | |
| Nov. 1, 2003 | | 0.21666666667 | 701.95 | $135.87 | 118.9872% | $161.66 |
| Feb. 1, 2004 | | 0.25000000000 | 705.45 | $136.54 | 118.8606% | $162.29 |
| Feb. 13, 2004 | $705.91 | | | | | |
| May 1, 2004 | | 0.21666666667 | 708.97 | $137.22 | 118.7340% | $162.93 |
| Aug. 1, 2004 | | 0.25000000000 | 712.50 | $137.91 | 118.6074% | $163.57 |
| Aug. 13, 2004 | $712.97 | | | | | |
| Nov. 1, 2004 | | 0.21666666667 | 716.06 | $138.60 | 118.4808% | $164.21 |
| Feb. 1, 2005 | | 0.25000000000 | 719.62 | $139.29 | 118.3542% | $164.85 |
| Feb. 13, 2005 | $720.10 | | | | | |
| May 1, 2005 | | 0.21666666667 | 723.22 | $139.98 | 118.2276% | $165.50 |
| Aug. 1, 2005 | | 0.25000000000 | 726.82 | $140.68 | 118.1010% | $166.14 |
| Aug. 13, 2005 | $727.30 | | | | | |
| Nov. 1, 2005 | | 0.21666666667 | 730.45 | $141.38 | 117.9744% | $166.80 |
| Feb. 1, 2006 | | 0.25000000000 | 734.09 | $142.09 | 117.8478% | $167.45 |
| Feb. 13, 2006 | $734.57 | | | | | |
| May 1, 2006 | | 0.21666666667 | 737.76 | $142.80 | 117.7212% | $168.10 |
| Aug. 1, 2006 | | 0.25000000000 | 741.43 | $143.51 | 117.5946% | $168.76 |
| Aug. 13, 2006 | $741.92 | | | | | |
| Nov. 1, 2006 | | 0.21666666667 | 745.14 | $144.22 | 117.4680% | $169.42 |
| Feb. 1, 2007 | | 0.25000000000 | 748.84 | $144.94 | 117.3414% | $170.08 |
| Feb. 13, 2007 | $749.34 | | | | | |
| May 1, 2007 | | 0.21666666667 | 752.59 | $145.67 | 117.2148% | $170.74 |
| Aug. 1, 2007 | | 0.25000000000 | 756.33 | $146.39 | 117.0882% | $171.41 |
| Aug. 13, 2007 | $756.83 | | | | | |
| Nov. 1, 2007 | | 0.21666666667 | 760.11 | $147.12 | 116.9616% | $172.08 |
| Feb. 1, 2008 | | 0.25000000000 | 763.90 | $147.86 | 116.8350% | $172.75 |
| Feb. 13, 2008 | $764.40 | | | | | |
| May 1, 2008 | | 0.21666666667 | 767.71 | $148.59 | 116.7084% | $173.42 |
| Aug. 1, 2008 | | 0.25000000000 | 771.54 | $149.33 | 116.5818% | $174.10 |
| Aug. 13, 2008 | $772.05 | | | | | |
| Nov. 1, 2008 | | 0.21666666667 | 775.39 | $150.08 | 116.4552% | $174.78 |
| Feb. 1, 2009 | | 0.25000000000 | 779.25 | $150.83 | 116.3286% | $175.46 |
| Feb. 13, 2009 | $779.77 | | | | | |
| May 1, 2009 | | 0.21666666667 | 783.15 | $151.58 | 116.2020% | $176.14 |
| Aug. 1, 2009 | | 0.25000000000 | 787.04 | $152.34 | 116.0754% | $176.82 |
| Aug. 13, 2009 | $787.56 | | | | | |
| Nov. 1, 2009 | | 0.21666666667 | 790.98 | $153.10 | 115.9488% | $177.51 |
| Feb. 1, 2010 | | 0.25000000000 | 794.91 | $153.86 | 115.8222% | $178.20 |
| Feb. 13, 2010 | $795.44 | | | | | |
| May 1, 2010 | | 0.21666666667 | 798.89 | $154.63 | 115.6956% | $178.90 |
| Aug. 1, 2010 | | 0.25000000000 | 802.86 | $155.40 | 115.5690% | $179.59 |
| Aug. 13, 2010 | $803.39 | | | | | |
| Nov. 1, 2010 | | 0.21666666667 | 806.88 | $156.17 | 115.4424% | $180.29 |
| Feb. 1, 2011 | | 0.25000000000 | 810.89 | $156.95 | 115.3158% | $180.99 |
| Feb. 13, 2011 | $811.43 | | | | | |
| May 1, 2011 | | 0.21666666667 | 814.94 | $157.74 | 115.1892% | $181.70 |
| Aug. 1, 2011 | | 0.25000000000 | 819.00 | $158.52 | 115.0626% | $182.40 |
| Aug. 13, 2011 | $819.54 | | | | | |
| Nov. 1, 2011 | | 0.21666666667 | 823.09 | $159.31 | 114.9360% | $183.11 |
| Feb. 1, 2012 | | 0.25000000000 | 827.19 | $160.11 | 114.8094% | $183.82 |
| Feb. 13, 2012 | $827.74 | | | | | |
| May 1, 2012 | | 0.21666666667 | 831.32 | $160.91 | 114.6828% | $184.53 |
| Aug. 1, 2012 | | 0.25000000000 | 835.46 | $161.71 | 114.5562% | $185.25 |
| Aug. 13, 2012 | $836.02 | | | | | |
| Nov. 1, 2012 | | 0.21666666667 | 839.64 | $162.52 | 114.4296% | $185.97 |
| Feb. 1, 2013 | | 0.25000000000 | 843.82 | $163.32 | 114.3030% | $186.69 |
| Feb. 13, 2013 | $844.38 | | | | | |
| May 1, 2013 | | 0.21666666667 | 848.03 | $164.14 | 114.1764% | $187.41 |
| Aug. 1, 2013 | | 0.25000000000 | 852.26 | $164.96 | 114.0498% | $188.13 |
| Aug. 13, 2013 | $852.82 | | | | | |
| Nov. 1, 2013 | | 0.21666666667 | 856.52 | $165.78 | 113.9232% | $188.86 |
| Feb. 1, 2014 | | 0.25000000000 | 860.78 | $166.61 | 113.7966% | $189.59 |
| Feb. 13, 2014 | $861.35 | | | | | |
| May 1, 2014 | | 0.21666666667 | 865.08 | $167.44 | 113.6700% | $190.33 |
| Aug. 1, 2014 | | 0.25000000000 | 869.39 | $168.27 | 113.5434% | $191.06 |
| Aug. 13, 2014 | $869.96 | | | | | |
| Nov. 1, 2014 | | 0.21666666667 | 873.73 | $169.11 | 113.4168% | $191.80 |
| Feb. 1, 2015 | | 0.25000000000 | 878.08 | $169.96 | 113.2902% | $192.54 |
| Feb. 13, 2015 | $878.66 | | | | | |
| May 1, 2015 | | 0.21666666667 | 882.47 | $170.81 | 113.1636% | $193.29 |
| Aug. 1, 2015 | | 0.25000000000 | 886.86 | $171.66 | 113.0370% | $194.04 |
| Aug. 13, 2015 | $887.45 | | | | | |
| Nov. 1, 2015 | | 0.21666666667 | 891.29 | $172.51 | 112.9104% | $194.79 |
| Feb. 1, 2016 | | 0.25000000000 | 895.73 | $173.37 | 112.7838% | $195.54 |
| Feb. 13, 2016 | $896.32 | | | | | |
| May 1, 2016 | | 0.21666666667 | 900.21 | $174.24 | 112.6572% | $196.29 |
| Aug. 1, 2016 | | 0.25000000000 | 904.69 | $175.11 | 112.5306% | $197.05 |
| Aug. 13, 2016 | $905.29 | | | | | |
| Nov. 1, 2016 | | 0.21666666667 | 909.21 | $175.98 | 112.4040% | $197.81 |
| Feb. 1, 2017 | | 0.25000000000 | 913.74 | $176.86 | 112.2774% | $198.57 |
| Feb. 13, 2017 | $914.34 | | | | | |
| May 1, 2017 | | 0.21666666667 | 918.30 | $177.74 | 112.1508% | $199.34 |
| Aug. 1, 2017 | | 0.25000000000 | 922.87 | $178.63 | 112.0242% | $200.10 |
| Aug. 13, 2017 | $923.48 | | | | | |
| Nov. 1, 2017 | | 0.21666666667 | 927.48 | $179.52 | 111.8976% | $200.88 |
| Feb. 1, 2018 | | 0.25000000000 | 932.10 | $180.41 | 111.7710% | $201.65 |
| Feb. 13, 2018 | $932.72 | | | | | |
| May 1, 2018 | | 0.21666666667 | 936.76 | $181.31 | 111.6444% | $202.43 |
| Aug. 1, 2018 | | 0.25000000000 | 941.42 | $182.22 | 111.5178% | $203.20 |
| Aug. 13, 2018 | $942.04 | | | | | |
| Nov. 1, 2018 | | 0.21666666667 | 946.13 | $183.13 | 111.3912% | $203.99 |
| Feb. 1, 2019 | | 0.25000000000 | 950.84 | $184.04 | 111.2646% | $204.77 |
| Feb. 13, 2019 | $951.47 | | | | | |
| May 1, 2019 | | 0.21666666667 | 955.59 | $184.96 | 111.1380% | $205.56 |
| Aug. 1, 2019 | | 0.25000000000 | 960.35 | $185.88 | 111.0114% | $206.35 |
| Aug. 13, 2019 | $960.98 | | | | | |
| Nov. 1, 2019 | | 0.21666666667 | 965.14 | $186.81 | 110.8848% | $207.14 |
| Feb. 1, 2020 | | 0.25000000000 | 969.95 | $187.74 | 110.7582% | $207.94 |
| Feb. 13, 2020 | $970.59 | | | | | |
| May 1, 2020 | | 0.21666666667 | 974.80 | $188.68 | 110.6316% | $208.74 |
| Aug. 1, 2020 | | 0.25000000000 | 979.65 | $189.62 | 110.5050% | $209.53 |
| Aug. 13, 2020 | $980.30 | | | | | |
| Nov. 1, 2020 | | 0.21666666667 | 984.54 | $190.56 | 110.3784% | $210.34 |
| Feb. 1, 2021 | | 0.25000000000 | 989.45 | $191.51 | 110.2518% | $211.15 |
| Feb. 13, 2021 | $990.10 | | | | | |
| May 1, 2021 | | 0.21666666667 | 994.39 | $192.47 | 110.1252% | $211.96 |
| Aug. 1, 2021 | | 0.25000000000 | 999.34 | $193.43 | 109.9986% | $212.77 |
| Aug. 13, 2021 | $1,000.00 | | | | | |

### EXAMPLE 1 (PART 2/7)

### EXAMPLE 1 (PART 3/7)

### EXAMPLE 1 (PART 4/7)

### EXAMPLE 1 (PART 5/7)

### EXAMPLE 1 (PART 6/7)

### EXAMPLE 1 (PART 7/7)

For example (see Example 1), assume a contingent conversion long term zero coupon instrument is issued on Aug. 13, 2001. Using the $1,000 price of the bond discounted by a yield of 2.0%, the price of the bond is calculated at issue to be $671.65. The stock price at issuance is $100.00. The initial conversion premium of 30% is applied to the stock price to calculate the initial conversion price of $130.00. The initial bond price of $671.65 divided by the initial conversion price of $130.00 will result in the conversion ratio of 5.1665. A trigger of 120%, decreased by 0.1266% per quarter, may be multiplied by the conversion price to determine the trigger price at which time the instrument is convertible by holders. In other embodiments, the trigger might remain constant or change at a different rate or more or less frequently.

The pricing of the financial instrument, at anytime, may be based on any of the following factors or any combination thereof:
1. the contingency,
2. the value of the underlying reference,
3. volatility in trading value of the underlying reference,
4. time until redemption, at option of issuer or holder,
5. time until maturity,
6. an interest rate, and
7. the value for which the financial instrument must be redeemed for on the redemption date.

In some embodiments, other contingencies may result in conversion, such as, for example, upon an issuer's optional redemption, or as a result of certain change of control events or anti-dilution provisions.

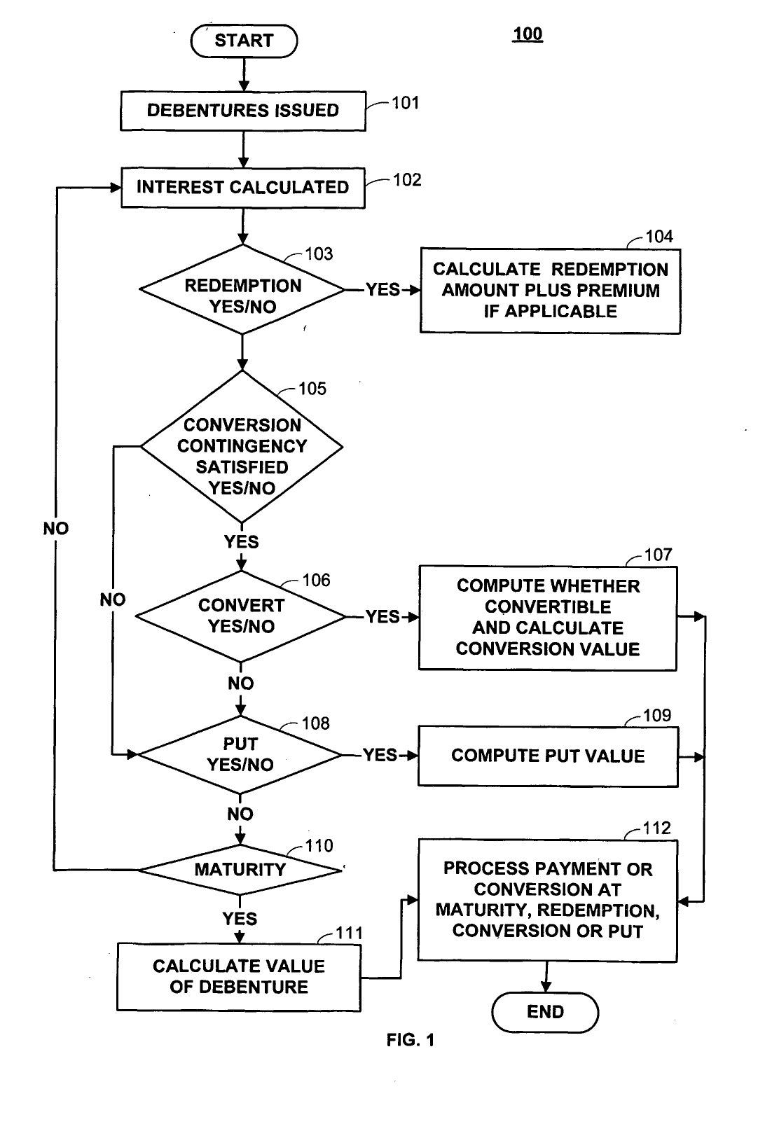

FIG. 1 is a flowchart of the illustrative steps involved in issuing and servicing contingently convertible financial instruments in accordance with some embodiments of the invention. The method starts at step 101 where a company, or other entity, issues a financial instrument (e.g., a debenture). Furthermore, at step 101, the original principal amount of an instrument may equal an amount based on pre-determined terms.

The method then proceeds to step 102, where interest payments are calculated. At step 103, if the issuer decides to redeem the instrument, the method proceeds to step 104 to calculate the redemption price. In a preferred embodiment, when a company decides to redeem its instruments, it may redeem some or all of the instruments issued under the same offering. Moreover, if the instruments are redeemed before a pre-selected date, the system may add a premium to the redemption amount.

At step 105, if the conversion contingency is satisfied, the method proceeds to step 106. If not, the method proceeds to step 108. The holder or other interested party, under step 106, may convert the instrument to the underlying security. The method may either allow a conversion or exchange at any time after issue, or may require that conversions or exchanges occur during an allocated period of time after issue.

At step 108, automatically evaluates whether the holder has put the security. If yes, the method, at step 109, computes the put value.

If, however, the method evaluates that the holder has not put the security at step 108, the method proceeds to step 111. At step 110, if the bond has reached maturity, the method then calculates the value of the instrument under step 111. Otherwise, the method return to step 102. Finally, at step 112, the method may process a conversion or a payment to the holder for the value of the matured instruments and any additional payments due.

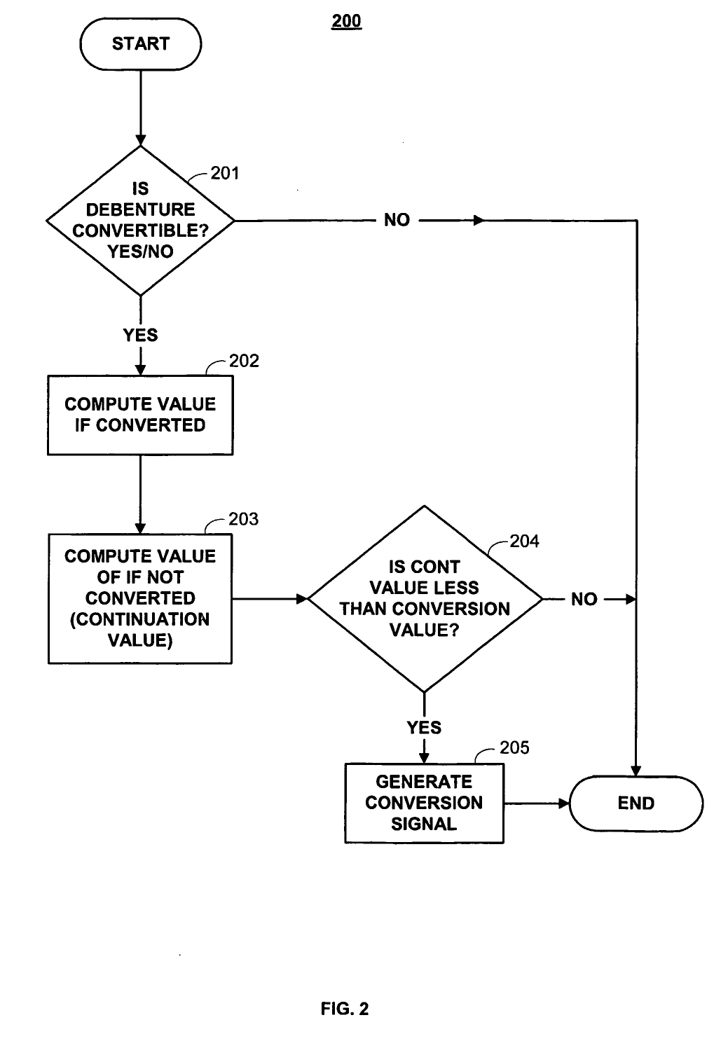

FIG. 2 is a flowchart of illustrative steps involved in determining whether to convert an instrument, in accordance with some embodiments of this invention. The method 200, at step 201 determines whether the instrument is convertible. If not, the method ends. If so, the method, at step 202, computes the value of the instrument if converted. At step 203, the method computes the value of the instrument if not converted. At 204, the method determines whether the continuation value is less than the conversion value. If so, a signal to convert is generated at step 205. If not, the method ends.

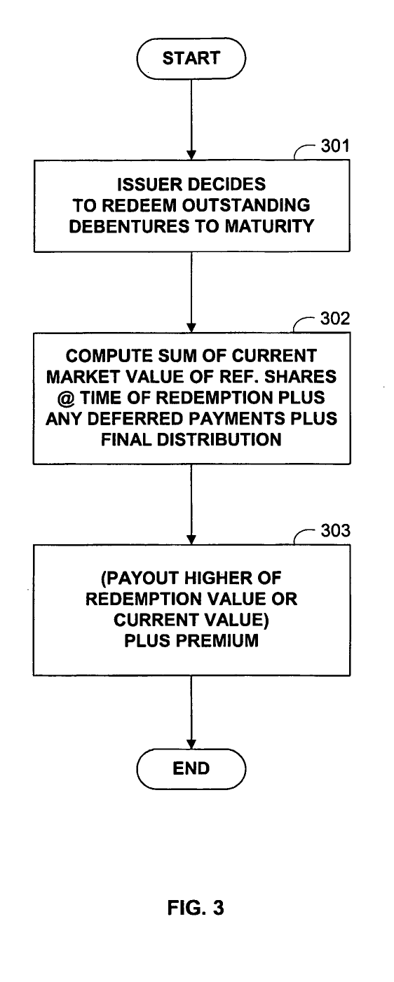

FIG. 3 is a flowchart of illustrative steps involved in redeeming the convertible instrument, as shown at step 103 of FIG. 1. The method 300 may be used when, for example, the issuer decides to redeem instruments issued under one offering document. At step 301, the issuer decides that it no longer wishes to keep the instruments outstanding and that it wants to redeem the instruments. At step 302, the method calculates the current market value of underlying shares at the time of redemption plus any deferred payments. At step 303, the method pays out the appropriate redemption amount, as calculated at step 302.

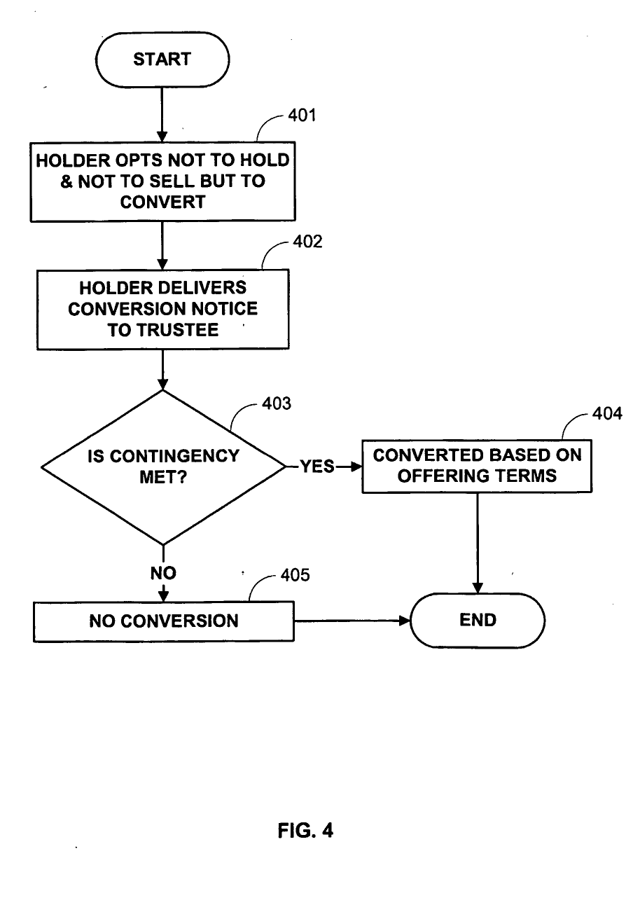

FIG. 4 is a flowchart of illustrative steps involved in converting convertible debt instruments as shown in FIG. 1 at step 105. The method may be used if, at step 401, the holder or other interested party determines that he or she wants to convert the instruments for the underlying security. Under this method, the holder can convert, or exchange depending on the types of instruments, but may incur a penalty. At step 402, the holder delivers a conversion notice to the trustee. At step 403, the method determines whether the conversion may occur by satisfying a contingency. Thus, at step 403, the method directs the instruments that may be converted to step 404, and directs those that may not to step 405. The method at step 404 converts or exchanges the instruments based on pre-determined offering terms.

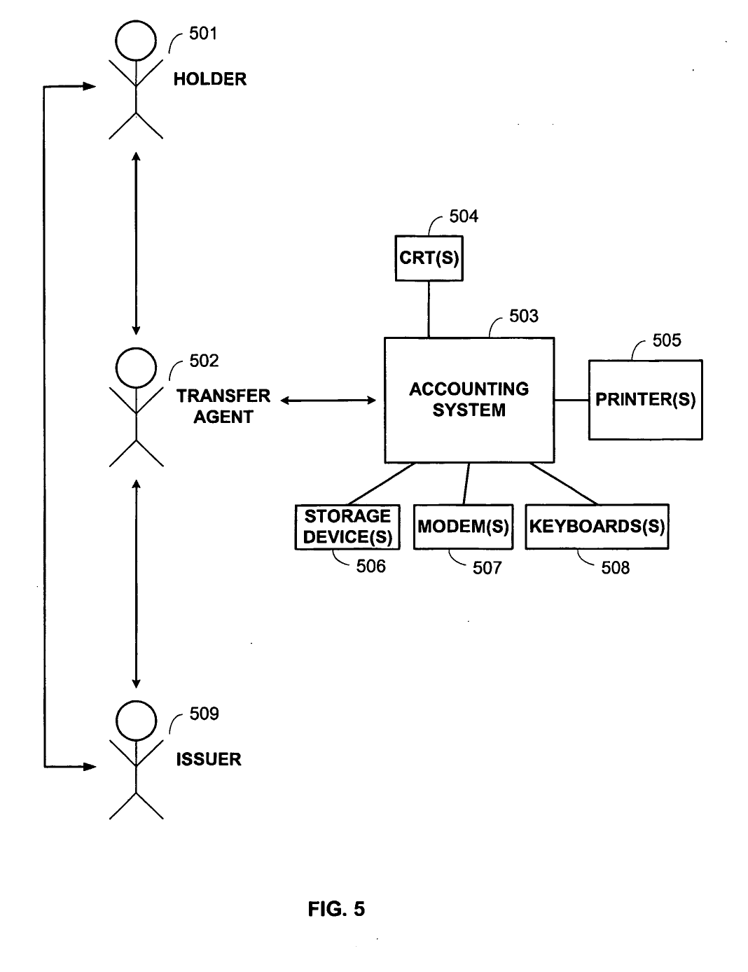

FIG. 5 shows the flow of information in a system for issuing and servicing contingent convertible financial instruments. A potential holder 501 requests an offering document that describes the terms of the security. Upon receiving the offering document and purchasing an instrument from the issuer 509 or through a third party, the transfer agent 502 may track the underlying reference security and service the security using, for example, the methods described in FIGS. 1-4. In doing so, the transfer agent preferably will use a computerized accounting system 503 capable of tracking the underlying reference security via data lines (network (not shown) or modem 507), tracking any dividend and pay-out from the underlying security, making calculations as disclosed in the instrument's offering document, and using a printer 505 to print periodic (e.g., annual) reports and statements reporting the instrument's value, and gains to the holder for tax reporting purposes.

In addition, the accounting system 503 may maintain pricing data (i.e., issue date, reference underlying instrument's price at time of issue, deferred dividends, etc.) in its mass storage system 506. In addition to the data received through the network or modem 507, the data may be inputted into the accounting system using keyboards 508. The system's modem 507 and network lines may be used to transfer funds to a holder or to a third party intermediary and the printer 505 may also print checks that are delivered directly to the third party or to a third party intermediary. Finally, the transfer agent may view the data from the accounting system using a CRT 504 or reports prepared by the accounting system 503 and printed using the system's printer 505.

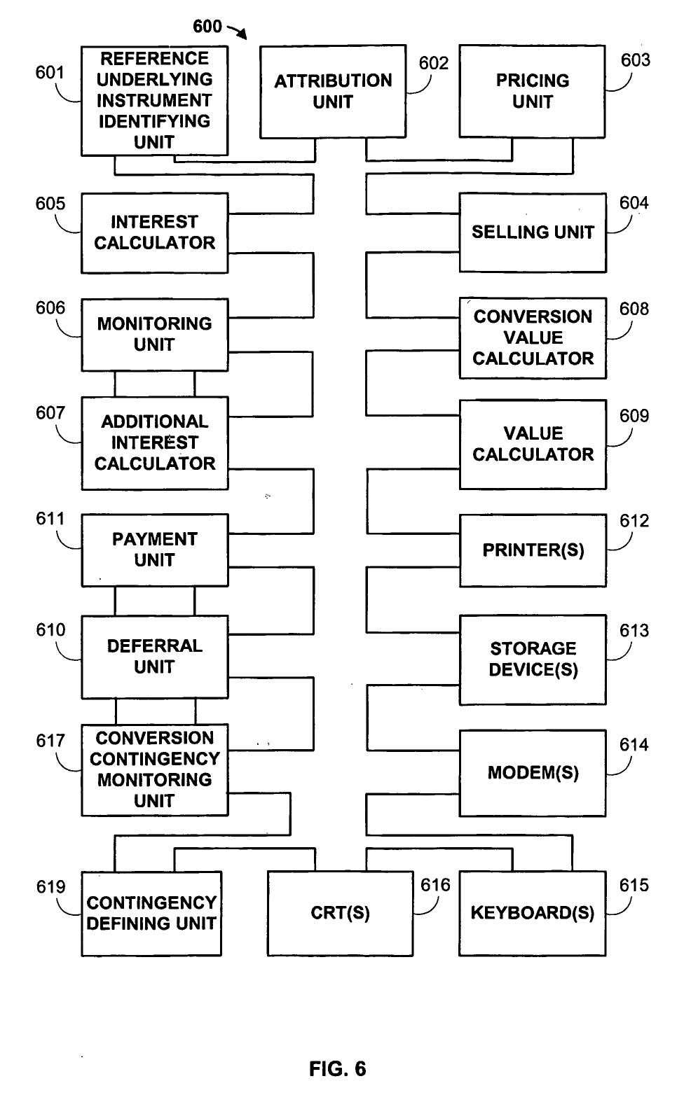

FIG. 6 offers an overview of some embodiments of a system 600 for implementing the method according to the invention. A reference underlying instrument identifying unit 601 is provided to identify (e.g., by user keyboard entry) a reference underlying instrument. An attribution unit 602 is used to attribute a number of the reference underlying instrument's shares to the instrument to be issued. Based on the price of the reference underlying instrument and the attributed number of reference instruments, a pricing unit 603 will establish a price for the instrument to be issued. The pricing unit may also use other factors to establish a price.

For example:
1. the volatility in the trading price of the reference underlying instrument;
2. the time until redemption of the instrument by either the issuer or holder;
3. the time until the instrument's maturity;
4. the instrument's redemption value;
5. an interest rate; and
6. the triggering contingency.

A selling unit 604 processes sales of the instrument to interested investors or buyers at the price determined by pricing unit 603. An interest calculator 605, throughout the term of the instrument, calculates interest due to holders on a periodic basis. Furthermore, a monitoring unit 606 tracks any dividend or pay-out of the underlying reference security. An additional interest calculator 607 calculates the additional interest owed to holders of the instrument.

If during the term of the instrument, a holder decides to convert the instrument, a conversion value calculator 608 calculates the conversion value of the instrument. The value calculator 609 calculates the value of the instrument at the time of redemption (if the instrument is redeemed early by the issuer), and may also be used at maturity (if the instrument remains outstanding until maturity).

A deferral unit 610 processes the results of interest calculator 605, and additional interest calculator 607, to determine if the calculated amount will be paid or deferred. If the payment amount is not deferred, payment is made by payment unit 611. Furthermore, payment unit 611 processes and makes payment based on the results of conversion value calculator 608, and value calculator 609. Payment may be made by check printed by a printer 612 as commanded by payment unit 611. Alternatively payment may be made via electronic transfer by modem, network, or other electronic methods of transferring funds 614. Reports listing payments of interest, and other financial data relevant to the holder for tax reporting purposes or other reportable data are printed using printer 612. Any such reports meant for holders preferably are printed and sent to holders periodically, and at least annually. Other reports may be required by regulatory agencies and are printed when required by the relevant regulations. Storage 613, modems 614, keyboards 615, and CRT 616 are used by the separate units of system 600, in a manner similar to that described in connection with FIG. 5. Conversion contingency unit 617 determines whether a contingency is satisfied and ultimately whether a conversion may occur.

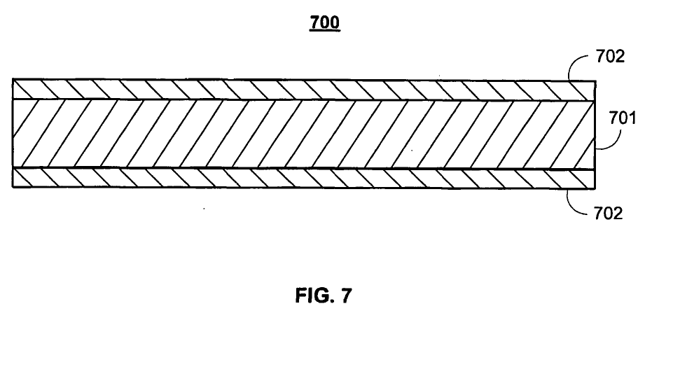

FIG. 7 presents a cross section of a magnetic data storage medium 700 which can be encoded with a machine executable program that can be carried out by a system such as system 500 of FIG. 5 or system 600 of FIG. 6. Medium 700 can be floppy diskette or hard disk, having a suitable substrate 701, which may be conventional, and a suitable coating 702, which may be conventional, on one or both sides, containing magnetic domains (not visible) whose polarity or orientation can be altered magnetically. Medium 700 may also have an opening (not shown) for receiving the spindle of a disk drive or other data storage device.

The magnetic domains of coating 702 of medium 700 are polarized or oriented so as to encode, in manner which may be conventional, a machine-executable program such as that described above in connection with FIGS. 1-4, for execution by a system such as system 500 of FIG. 5 or system 600 of FIG. 6.

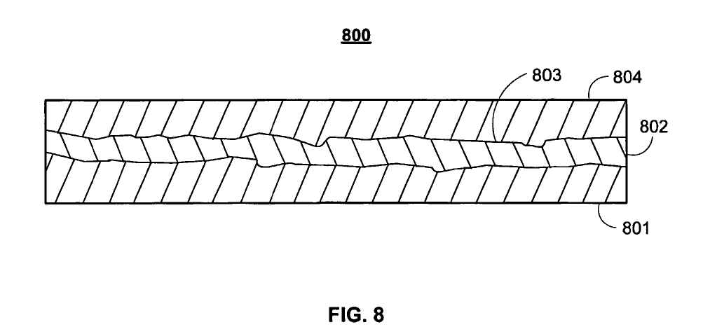

FIG. 8 shows a cross section of an optically-readable data storage medium 800 which also can be encoded with such a machine-executable program, which can be carried out by a system such as system 500 of FIG. 5 or system 600 of FIG. 6. Medium 800 can be a conventional compact disk read only memory (CD-ROM) or a rewritable medium such as a CD-R or CD-RW disk or a magneto-optical disk which is optically readable and magneto-optically writeable. Medium 800 preferably has a suitable substrate 801, which may be conventional, and a suitable coating 802, which may be conventional, usually on one side of substrate 801.

In the case of a CD-ROM, as is well known, coating 802 is reflective and is impressed with a plurality of pits 803 to encode the machine-executable program. The arrangement of pits is read by reflecting laser light off the surface of coating 802. A protective coating 804, which preferably is substantially transparent, is provided on top of coating 802.

In the case of magneto-optical disk, as is well known, coating 802 has no pits 803, but has a plurality of magnetic domains whose polarity or orientation can be changed magnetically when heated above a certain temperature, as by a laser (not shown). The orientation of the domains can be read by measuring the polarization of laser light reflected from coating 802. The arrangement of the domains encodes the program as described above.

Thus, a convertible financial instrument with contingent conversion, and systems and methods for offering and servicing the same are provided. One skilled in the art will appreciate that the present invention can be practiced by other than the described embodiments, which are presented for purposes of illustration and not of limitation.

1. A financial services method associated with a financial instrument, said method comprising:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

2. The method of claim 1 further comprising:
establishing a value for said financial instrument.

3. The method of claim 2 further comprising:
selling said financial instrument.

4. The method of claim 3, wherein said selling said financial instrument comprises selling said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

5. The method of claim 3, wherein said selling said financial instrument comprises auctioning said financial instrument.

6. The method of claim 3, wherein said selling said financial instrument comprises selling a derivative of said financial instrument.

7. The method of claim 3, wherein said selling said financial instrument comprises selling a part of said financial instrument.

8. The method of claim 3 further comprising:
monitoring for satisfaction of said contingency.

9. The method of claim 2 further comprising:
monitoring for satisfaction of said contingency.

10. The method of claim 2, wherein said establishing a value for said financial instrument comprises basing said value for said financial instrument on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

11. The method of claim 1 further comprising: selling said financial instrument.

12. The method of claim 11, wherein said selling said financial instrument comprises selling said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

13. The method of claim 11, wherein said selling said financial instrument comprises auctioning said financial instrument.

14. The method of claim 11, wherein said selling said financial instrument comprises selling a derivative of said financial instrument.

15. The method of claim 11, wherein said selling said financial instrument comprises selling a part of said financial instrument.

16. The method of claim 11 further comprising:
monitoring for satisfaction of said contingency.

17. The method of claim 1 further comprising: monitoring for satisfaction of said contingency.

18. The method of claim 17, wherein said monitoring for satisfaction comprises comparing market data to requirements of said contingency.

19. The method of claim 17, wherein said monitoring comprises monitoring at periodic intervals.

20. The method of claim 17, wherein said monitoring comprises monitoring at predetermined times.

21. The method of claim 17, wherein said monitoring comprises monitoring realtime data.

22. The method of claim 17, further comprising processing a conversion on satisfaction of said contingency.

23. The method of claim 1, wherein said defining a contingency comprises basing said contingency on an event related to said financial instrument.

24. The method of claim 23, wherein said basing said contingency on said event related to said financial instrument comprises setting said contingency as satisfied once an observed value of said financial instrument at least:
a. exceeds a predetermined metric during a predetermined period of time, or
b. is equal to a predetermined metric during a predetermined period of time, or
c. is less than a predetermined metric during a predetermined period of time.

25. The method of claim 1, wherein said defining a contingency comprises setting said contingency as satisfied when the closing sale value of said underlying reference for at least a pre-determined number of trading days is greater than a pre-determined percentage of the conversion value.

26. The method of claim 1, wherein said defining a contingency comprises setting said contingency as satisfied when the closing sale value of said underlying reference for at least a pre-determined number of trading days is less than a pre-determined percentage of the conversion value.

27. The method of claim 1, wherein said defining a contingency comprises setting said contingency as satisfied when said financial instrument is called for redemption.

28. The method of claim 1, wherein said defining a contingency comprises setting said contingency as satisfied upon the occurrence of a corporate transaction.

29. The method of claim 28, wherein said setting said contingency as satisfied upon the occurrence of a corporate transaction comprises setting said contingency as satisfied upon the occurrence of a predetermined type of distribution to shareholders.

30. The method of claim 28, wherein said setting said contingency as satisfied upon the occurrence of a corporate transaction comprises setting said contingency as satisfied upon the occurrence of a merger.

31. The method of claim 28, wherein said setting said contingency as satisfied upon the occurrence of a corporate transaction comprises setting said contingency as satisfied upon the occurrence of a consolidation.

32. The method of claim 1, wherein said defining a contingency comprises setting said contingency as satisfied during any period in which the credit rating of the instrument is below a predetermined level.

33. The method of claim 1, wherein said defining a contingency comprises basing said contingency on an instrument other than said financial instrument.

34. The method of claim 33, wherein said basing said contingency on said instrument other than said financial instrument comprises setting said contingency as satisfied once an observed value of said instrument at least:
a. exceeds a predetermined metric during a predetermined period of time, or
b. is equal to a predetermined metric during a predetermined period of time, or
c. is less than a predetermined metric during a predetermined period of time.

35. The method of claim 33, wherein said defining a contingency comprises establishing at least one of:
a. a contingency with at least one trigger, and
b. multiple contingencies each with at least one trigger.

36. The method of claim 35, wherein said establishing at least one trigger comprises setting said trigger at an amount equal to a multiple of a prevailing market rate for a financial instrument.

37. The method of claim 36, wherein said setting said trigger equal to a multiple comprises using a multiple equal to 1.

38. The method of claim 36, wherein said setting said trigger equal to a multiple comprises using a multiple less than 1.

39. The method of claim 36, wherein said setting said trigger equal to a multiple comprises using a multiple greater than 1.

40. The method of claim 35, wherein said establishing at least one trigger comprises setting said trigger equal to a multiple of a formula amount.

41. The method of claim 40, wherein said setting said trigger equal to a multiple comprises using a multiple equal to 1.

42. The method of claim 40, wherein said setting said trigger equal to a multiple comprises using a multiple less than 1.

43. The method of claim 40, wherein said setting said trigger equal to a multiple comprises using a multiple greater than 1.

44. The method of claim 1, wherein said attributing a number of said underlying references to said financial instrument comprises attributing a variable number of said underlying references to each unit of said financial instrument.

45. The method of claim 1, wherein said attributing a number of said underlying references to said financial instrument comprises attributing a constant number of said underlying references to each unit of said financial instrument.

46. The method of claim 1, wherein said identifying an underlying reference comprises identifying said underlying reference that said financial instrument converts into.

47. The method of claim 1, wherein said identifying an underlying reference comprises basing an exchange value of said financial instrument on said underlying reference.

48. The method of claim 1, wherein said interested party comprises a holder of said financial instrument.

49. A financial services method comprising establishing a value for a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

50. The method of claim 49, wherein said establishing a value for said financial instrument comprises basing said value for said financial instrument on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

51. The method of claim 49, wherein said interested party comprises a holder of said financial instrument.

52. A financial services method comprising selling a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

53. The method of claim 52, wherein said selling said financial instrument comprises selling said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

54. The method of claim 52, wherein said selling said financial instrument comprises auctioning said financial instrument.

55. The method of claim 52, wherein said selling said financial instrument comprises selling a derivative of said financial instrument.

56. The method of claim 52, wherein said selling said financial instrument comprises selling a part of said financial instrument.

57. The method of claim 52, wherein said identifying an underlying reference comprises identifying said underlying reference that said financial instrument converts into.

58. The method of claim 52, wherein said identifying an underlying reference comprises basing an exchange value of said financial instrument on said underlying reference.

59. The method of claim 52, wherein said interested party comprises a holder of said financial instrument.

60. A financial services method comprising buying a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

61. The method of claim 60, wherein said buying said financial instrument comprises buying said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

62. The method of claim 60, wherein said buying said financial instrument comprises bidding for said financial instrument.

63. The method of claim 60, wherein said buying said financial instrument comprises buying a derivative of said financial instrument.

64. The method of claim 60, wherein said buying said financial instrument comprises buying a part of said financial instrument.

65. The method of claim 60, wherein said identifying a underlying reference comprises identifying said underlying reference that said financial instrument converts into.

66. The method of claim 60, wherein said identifying an underlying reference comprises basing an exchange value of said financial instrument on said underlying reference.

67. The method of claim 60, wherein said interested party comprises a holder of said financial instrument.

68. A financial services method comprising selling a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency;
establishing a value for said financial instrument.

69. The method of claim 68, wherein said establishing a value for said financial instrument comprises establishing a value for said financial instrument based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

70. The method of claim 68, wherein said selling said financial instrument comprises auctioning said financial instrument.

71. The method of claim 68, wherein said selling said financial instrument comprises selling a derivative of said financial instrument.

72. The method of claim 68, wherein said selling said financial instrument comprises selling a part of said financial instrument.

73. The method of claim 68, wherein said identifying an underlying reference comprises identifying said underlying reference that said financial instrument converts into.

74. The method of claim 68, wherein said identifying an underlying reference comprises basing an exchange value of said financial instrument on said underlying reference.

75. The method of claim 68, wherein said interested party comprises a holder of said financial instrument.

76. A financial services method comprising buying a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency;
establishing a value for said financial instrument.

77. The method of claim 76, wherein said identifying an underlying reference comprises identifying said underlying reference that said financial instrument converts into.

78. The method of claim 76, wherein said identifying an underlying reference comprises basing an exchange value of said financial instrument on said underlying reference.

79. The method of claim 76, wherein said establishing a value for said financial instrument comprises establishing a value for said financial instrument based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

80. The method of claim 76, wherein said buying said financial instrument comprises bidding for said financial instrument.

81. The method of claim 76, wherein said buying said financial instrument comprises buying a derivative of said financial instrument.

82. The method of claim 76, wherein said buying said financial instrument comprises buying a part of said financial instrument.

83. The method of claim 76, wherein said interested party comprises a holder of said financial instrument.

84. A financial services method comprising monitoring for satisfaction of a contingency for a financial instrument created by:
identifying an underlying reference for said financial instrument, said underlying reference having a value;
attributing a number of said underlying references to said financial instrument;
defining said contingency, said financial instrument becoming convertible so that an interested party is given an option to convert said financial instrument on occurrence of said contingency.

85. The method of claim 84, wherein said monitoring for satisfaction comprises comparing market data to requirements of said contingency.

86. The method of claim 84, wherein said monitoring comprises monitoring at periodic intervals.

87. The method of claim 84, wherein said monitoring comprises monitoring at predetermined times.

88. The method of claim 84, wherein said monitoring comprises monitoring realtime data.

89. The method of claim 84 wherein said monitoring further comprises processing said conversion on both:
a. determining satisfaction of said contingency, and
b. determining execution of said option to convert by said interested party.

90. The method of claim 89 wherein said determining execution of said option to convert comprises determining execution of said option to convert by a holder of said financial instrument.

91. The method of claim 84, wherein said identifying an underlying reference comprises identifying said underlying reference that said financial instrument converts into.

92. The method of claim 84, wherein said identifying an underlying reference comprises basing an exchange value of said financial instrument on said underlying reference.

93. The method of claim 84, wherein said interested party comprises a holder of said financial instrument.

94. A financial services system associated with a financial instrument, said system comprising:
means for identifying an underlying reference for said financial instrument, said underlying reference having a value;
means for attributing a number of said underlying references to said financial instrument;
means for defining a contingency, said financial instrument becoming convertible so that an interested party is given an option to convert said financial instrument on occurrence of said contingency.

95. The system of claim 94 further comprising:
means for establishing a value for said financial instrument.

96. The system of claim 95 further comprising:
means for selling said financial instrument.

97. The system of claim 96, wherein said means for selling said financial instrument comprises means for selling said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

98. The system of claim 96, wherein said means for selling said financial instrument comprises means for auctioning said financial instrument.

99. The system of claim 96, wherein said means for selling said financial instrument comprises means for selling a derivative of said financial instrument.

100. The system of claim 96, wherein said means for selling said financial instrument comprises means for selling a part of said financial instrument.

101. The system of claim 96 further comprising:
means for monitoring for satisfaction of said contingency.

102. The system of claim 95 further comprising:
means for monitoring for satisfaction of said contingency.

103. The system of claim 95, wherein said means for establishing a value for said financial instrument comprises means for basing said value for said financial instrument on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

104. The system of claim 94 further comprising:
means for selling said financial instrument.

105. The system of claim 104, wherein said means for selling said financial instrument comprises means for selling said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

106. The system of claim 104, wherein said means for selling said financial instrument comprises means for auctioning said financial instrument.

107. The system of claim 104, wherein said means for selling said financial instrument comprises means for selling a derivative of said financial instrument.

108. The system of claim 104, wherein said means for selling said financial instrument comprises means for selling a part of said financial instrument.

109. The system of claim 104 further comprising:
means for monitoring for satisfaction of said contingency.

110. The system of claim 94 further comprising: means for monitoring for satisfaction of said contingency.

111. The system of claim 110, wherein said means for monitoring for satisfaction comprises means for comparing market data to requirements of said contingency.

112. The system of claim 110, wherein said means for monitoring comprises means for monitoring at periodic intervals.

113. The system of claim 110, wherein said means for monitoring comprises means for monitoring at predetermined times.

114. The system of claim 110, wherein said means for monitoring comprises means for monitoring realtime data.

115. The system of claim 110, further comprising means for processing a conversion on satisfaction of said contingency.

116. The system of claim 94, wherein said means for defining a contingency comprises means for basing said contingency on an event related to said financial instrument.

117. The system of claim 116, wherein said means for basing said contingency on said event related to said financial instrument comprises means for setting said contingency as satisfied once an observed value of said financial instrument at least:
a. exceeds a predetermined metric during a predetermined period of time, or
b. is equal to a predetermined metric during a predetermined period of time, or
c. is less than a predetermined metric during a predetermined period of time.

118. The system of claim 94, wherein said means for defining a contingency comprises means for setting said contingency as satisfied when the closing sale value of said underlying reference for at least a pre-determined number of trading days is greater than a pre-determined percentage of the conversion value.

119. The system of claim 94, wherein said means for defining a contingency comprises means for setting said contingency as satisfied when the closing sale value of said underlying reference for at least a pre-determined number of trading days is less than a pre-determined percentage of the conversion value.

120. The system of claim 94, wherein said means for defining a contingency comprises means for setting said contingency as satisfied when said financial instrument is called for redemption.

121. The system of claim 94, wherein said means for defining a contingency comprises means for setting said contingency as satisfied upon the occurrence of a corporate transaction.

122. The system of claim 121, wherein said means for setting said contingency as satisfied upon the occurrence of a corporate transaction comprises means for setting said contingency as satisfied upon the occurrence of a predetermined type of distribution to shareholders.

123. The system of claim 121, wherein said means for setting said contingency as satisfied upon the occurrence of a corporate transaction comprises means for setting said contingency as satisfied upon the occurrence of a merger.

124. The system of claim 121, wherein said means for setting said contingency as satisfied upon the occurrence of a corporate transaction comprises means for setting said contingency as satisfied upon the occurrence of a consolidation.

125. The system of claim 94, wherein said means for defining a contingency comprises means for setting said contingency as satisfied during any period in which the credit rating of the instrument is below a predetermined level.

126. The system of claim 94, wherein said means for defining a contingency comprises means for basing said contingency on an instrument other than said financial instrument.

127. The system of claim 126, wherein said means for basing said contingency on said instrument other than said financial instrument comprises means for setting said contingency as satisfied once an observed value of said instrument at least:
a. exceeds a predetermined metric during a predetermined period of time, or
b. is equal to a predetermined metric during a predetermined period of time, or
c. is less than a predetermined metric during a predetermined period of time.

128. The system of claim 94, wherein said means for defining a contingency comprises means for establishing at least one of:
a. a contingency with at least one trigger, and
b. multiple contingencies each with at least one trigger.

129. The system of claim 128, wherein said means for establishing at least one trigger comprises means for setting said trigger at an amount equal to a multiple of a prevailing market rate for a financial instrument.

130. The system of claim 129, wherein said means for setting said trigger equal to a multiple comprises means for using a multiple equal to 1.

131. The system of claim 129, wherein said means for setting said trigger equal to a multiple comprises means for using a multiple less than 1.

132. The system of claim 129, wherein said means for setting said trigger equal to a multiple comprises means for using a multiple greater than 1.

133. The system of claim 128, wherein said means for establishing at least one trigger comprises means for setting said trigger equal to a multiple of a formula amount.

134. The system of claim 133, wherein said means for setting said trigger equal to a multiple comprises means for using a multiple equal to 1.

135. The system of claim 133, wherein said means for setting said trigger equal to a multiple comprises means for using a multiple less than 1.

136. The system of claim 133, wherein said means for setting said trigger equal to a multiple comprises means for using a multiple greater than 1.

137. The system of claim 94, wherein said means for attributing a number of said underlying references to said financial instrument comprises means for attributing a variable number of said underlying references to each unit of said financial instrument.

138. The system of claim 94, wherein said means for attributing a number of said underlying references to said financial instrument comprises means for attributing a constant number of said underlying references to each unit of said financial instrument.

139. The system of claim 94, wherein said means for identifying an underlying reference comprises means for identifying said underlying reference that said financial instrument converts into.

140. The system of claim 94, wherein said means for identifying an underlying reference comprises means for basing an exchange value of said financial instrument on said underlying reference.

141. The system of claim 94, wherein said interested party comprises a holder of said financial instrument.

142. A financial services system comprising means for establishing a value for a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

143. The system of claim 142, wherein said means for establishing a value for said financial instrument comprises means for basing said value for said financial instrument on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

144. The system of claim 142, wherein said interested party comprises a holder of said financial instrument.

145. A financial services system comprising means for selling a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

146. The system of claim 145, wherein said means for selling said financial instrument comprises means for selling said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

147. The system of claim 145, wherein said means for selling said financial instrument comprises means for auctioning said financial instrument.

148. The system of claim 145, wherein said means for selling said financial instrument comprises means for selling a derivative of said financial instrument.

149. The system of claim 145, wherein said means for selling said financial instrument comprises means for selling a part of said financial instrument.

150. The system of claim 145, wherein said identifying an underlying reference comprises identifying said underlying reference that said financial instrument converts into.

151. The system of claim 145, wherein said identifying an underlying reference comprises basing an exchange value of said financial instrument on said underlying reference.

152. The system of claim 145, wherein said interested party comprises a holder of said financial instrument.

153. A financial services system comprising means for buying a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

154. The system of claim 153, wherein said means for buying said financial instrument comprises means for buying said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

155. The system of claim 153, wherein said means for buying said financial instrument comprises means for bidding for said financial instrument.

156. The system of claim 153, wherein said means for buying said financial instrument comprises means for buying a derivative of said financial instrument.

157. The system of claim 153, wherein said means for buying said financial instrument comprises means for buying a part of said financial instrument.

158. The system of claim 153, wherein said identifying an underlying reference comprises identifying said underlying reference that said financial instrument converts into.

159. The system of claim 153, wherein said identifying an underlying reference comprises basing an exchange value of said financial instrument on said underlying reference.

160. The system of claim 153, wherein said interested party comprises a holder of said financial instrument.

161. A financial services system comprising means for selling a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency;
establishing a value for said financial instrument.

162. The system of claim 161, wherein said establishing a value for said financial instrument comprises establishing a value for said financial instrument based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

163. The system of claim 161, wherein said means for selling said financial instrument comprises means for auctioning said financial instrument.

164. The system of claim 161, wherein said means for selling said financial instrument comprises means for buying a derivative of said financial instrument.

165. The system of claim 161, wherein said means for selling said financial instrument comprises means for selling a part of said financial instrument.

166. The system of claim 161, wherein said identifying an underlying reference comprises identifying said underlying reference that said financial instrument converts into.

167. The system of claim 161, wherein said identifying an underlying reference comprises basing an exchange value of said financial instrument on said underlying reference.

168. The system of claim 161, wherein said interested party comprises a holder of said financial instrument.

169. A financial services system comprising means for buying a financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency;
establishing a value for said financial instrument.

170. The system of claim 169, wherein said identifying an underlying reference comprises identifying said underlying reference that said financial instrument converts into.

171. The system of claim 169, wherein said identifying an underlying reference comprises basing an exchange value of said financial instrument on said underlying reference.

172. The system of claim 169, wherein said establishing a value for said financial instrument comprises establishing a value for said financial instrument based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

173. The system of claim 169, wherein said means for buying said financial instrument comprises means for bidding for said financial instrument.

174. The system of claim 169, wherein said means for buying said financial instrument comprises means for buying a derivative of said financial instrument.

175. The system of claim 169, wherein said means for buying said financial instrument comprises means for buying a part of said financial instrument.

176. The system of claim 169, wherein said interested party comprises a holder of said financial instrument.

177. A financial services system comprising means for monitoring for satisfaction of a contingency for a financial instrument created by:
identifying an underlying reference for said financial instrument, said underlying reference having a value;
attributing a number of said underlying references to said financial instrument;
defining said contingency, said financial instrument becoming convertible so that an interested party is given an option to convert said financial instrument on occurrence of said contingency.

178. The system of claim 177, wherein said means for monitoring for satisfaction comprises means for comparing market data to requirements of said contingency.

179. The system of claim 177, wherein said means for monitoring comprises means for monitoring at periodic intervals.

180. The system of claim 177, wherein said means for monitoring comprises means for monitoring at predetermined times.

181. The system of claim 177, wherein said means for monitoring comprises means for monitoring realtime data.

182. The system of claim 177, wherein said means for monitoring further comprises means for processing a conversion on satisfaction of said contingency.

183. The system of claim 177, wherein said identifying an underlying reference comprises identifying said underlying reference that said financial instrument converts into.

184. The system of claim 177, wherein said identifying an underlying reference comprises basing an exchange value of said financial instrument on said underlying reference.

185. The system of claim 177, wherein said interested party comprises a holder of said financial instrument.

186. A financial services system associated with a financial instrument, said system comprising:
an underlying reference identifying unit that identifies an underlying reference;
an attribution unit that attributes a number of said underlying references to said financial instrument;
a contingency defining unit that defines a contingency at which time said financial instrument becomes convertible so that an interested party is given an option to convert said financial instrument.

187. The system of claim 186 further comprising:
a pricing value unit that establishes a value for said financial instrument.

188. The system of claim 187 further comprising:
a selling unit that sells said financial instrument.

189. The system of claim 188 further comprising:
a monitoring unit that monitors for satisfaction of said contingency.

190. The system of claim 187 further comprising:
a monitoring unit that monitors for satisfaction of said contingency.

191. The system of claim 186 further comprising:
a selling unit that sells said financial instrument.

192. The system of claim 191 further comprising:
a monitoring unit that monitors for satisfaction of said contingency.

193. The system of claim 186 further comprising:
a monitoring unit that monitors for satisfaction of said contingency.

194. The system of claim 186 further comprising a printer that prints periodic reports.

195. The system of claim 186, wherein said interested party comprises a holder of said financial instrument.

196. A financial services system comprising a pricing value unit that establishes a value for a financial instrument created by:
a underlying reference identifying unit that identifies an underlying reference unit;
an attribution unit that attributes a number of said underlying references to said financial instrument;
a contingency defining unit that defines a contingency at which time said financial instrument becomes convertible so that an interested party is given an option to convert said financial instrument.

197. The system of claim 196, wherein said interested party comprises a holder of said financial instrument.

198. A financial services system comprising a selling unit that sells a financial instrument created by:
an underlying reference unit that identifies an underlying reference;
an attribution unit that attributes a number of said underlying references to said financial instrument;
a contingency defining unit that defines a contingency at which time said financial instrument becomes convertible so that an interested party is given an option to convert said financial instrument.

199. The system of claim 198, further comprising a printer that prints periodic reports.

200. The system of claim 198, wherein said interested party comprises a holder of said financial instrument.

201. A financial services system comprising a monitoring unit that monitors for satisfaction of a contingency for a financial instrument created by:
an underlying reference identifying unit that identifies an underlying reference;
an attribution unit that attributes a number of said underlying references to said financial instrument;
a contingency defining unit that defines said contingency at which time said financial instrument becomes convertible so that an interested party is given an option to convert said financial instrument.

202. The system of claim 201, further comprising a printer that prints periodic reports.

203. The system of claim 201, wherein said interested party comprises a holder of said financial instrument.

204. A financial instrument derived in accordance with a method, said method comprising:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

205. The financial instrument derived in accordance with said method of claim 204, said method further comprising:
establishing a value for said financial instrument.

206. The financial instrument derived in accordance with said method of claim 205, said method further comprising:
selling said financial instrument.

207. The financial instrument derived in accordance with said method of claim 206, wherein said selling said financial instrument comprises selling said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

208. The financial instrument derived in accordance with said method of claim 206, wherein said selling said financial instrument comprises auctioning said financial instrument.

209. The financial instrument derived in accordance with said method of claim 206, wherein said selling said financial instrument comprises selling a derivative of said financial instrument.

210. The financial instrument derived in accordance with said method of claim 206, wherein said selling said financial instrument comprises selling a part of said financial instrument.

211. The financial instrument derived in accordance with said method of claim 206, said method further comprising:
monitoring for satisfaction of said contingency.

212. The financial instrument derived in accordance with said method of claim 205, said method further comprising:
monitoring for satisfaction of said contingency.

213. The financial instrument derived in accordance with said method of claim 205, wherein said establishing a value for said financial instrument comprises basing said value for said financial instrument on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

214. The financial instrument derived in accordance with said method of claim 204, said method further comprising:
selling said financial instrument.

215. The financial instrument derived in accordance with said method of claim 214, wherein said selling said financial instrument comprises selling said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

216. The financial instrument derived in accordance with said method of claim 214, wherein said selling said financial instrument comprises auctioning said financial instrument.

217. The financial instrument derived in accordance with said method of claim 214, wherein said selling said financial instrument comprises selling a derivative of said financial instrument.

218. The financial instrument derived in accordance with said method of claim 214, wherein said selling said financial instrument comprises selling a part of said financial instrument.

219. The financial instrument derived in accordance with said method of claim 214, said method further comprising:
monitoring for satisfaction of said contingency.

220. The financial instrument derived in accordance with said method of claim 204, said method further comprising:
monitoring for satisfaction of said contingency.

221. The financial instrument derived in accordance with said method of claim 220, wherein said monitoring for satisfaction comprises comparing market data to requirements of said contingency.

222. The financial instrument derived in accordance with said method of claim 220, wherein said monitoring comprises monitoring at periodic intervals.

223. The financial instrument derived in accordance with said method of claim 220, wherein said monitoring comprises monitoring at predetermined times.

224. The financial instrument derived in accordance with said method of claim 220, wherein said monitoring comprises monitoring realtime data.

225. The financial instrument derived in accordance with said method of claim 220, said method further comprising processing a conversion on satisfaction of said contingency.

226. The financial instrument derived in accordance with said method of claim 204, wherein said defining a contingency comprises basing said contingency on an event related to said financial instrument.

227. The financial instrument derived in accordance with said method of claim 226, wherein said basing said contingency on an event related to said financial instrument comprises setting said contingency as satisfied once an observed value of said financial instrument at least:
a. exceeds a predetermined metric during a predetermined period of time, or
b. is equal to a predetermined metric during a predetermined period of time, or
c. is less than a predetermined metric during a predetermined period of time.

228. The financial instrument derived in accordance with said method of claim 204, wherein said defining a contingency comprises setting said contingency as satisfied when the closing sale value of said underlying reference for at least a pre-determined number of trading days is greater than a pre-determined percentage of the conversion value.

229. The financial instrument derived in accordance with said method of claim 204, wherein said defining a contingency comprises setting said contingency as satisfied when the closing sale value of said underlying reference for at least a pre-determined number of trading days is less than a pre-determined percentage of the conversion value.

230. The financial instrument derived in accordance with said method of claim 204, wherein said defining a contingency comprises setting said contingency as satisfied when said financial instrument is called for redemption.

231. The financial instrument derived in accordance with said method of claim 204, wherein said defining a contingency comprises setting said contingency as satisfied upon the occurrence of a corporate transaction.

232. The financial instrument derived in accordance with said method of claim 231, wherein said setting said contingency as satisfied upon the occurrence of a corporate transaction comprises setting said contingency as satisfied upon the occurrence of a predetermined type of distribution to shareholders.

233. The financial instrument derived in accordance with said method of claim 231, wherein said setting said contingency as satisfied upon the occurrence of a corporate transaction comprises setting said contingency as satisfied upon the occurrence of a merger.

234. The financial instrument derived in accordance with said method of claim 231, wherein said setting said contingency as satisfied upon the occurrence of a corporate transaction comprises setting said contingency as satisfied upon the occurrence of a consolidation.

235. The financial instrument derived in accordance with said method of claim 204, wherein said defining a contingency comprises setting said contingency as satisfied during any period in which the credit rating of the instrument is below a predetermined level.

236. The financial instrument derived in accordance with said method of claim 231, wherein said defining a contingency comprises basing said contingency on an instrument other than said financial instrument.

237. The financial instrument derived in accordance with said method of claim 236, wherein said basing said contingency on an instrument other than said financial instrument comprises setting said contingency as satisfied once an observed value of said instrument at least:
a. exceeds a predetermined metric during a predetermined period of time, or
b. is equal to a predetermined metric during a predetermined period of time, or
c. is less than a predetermined metric during a predetermined period of time.

238. The financial instrument derived in accordance with said method of claim 231, wherein said defining a contingency comprises establishing at least one of:
a. a contingency with at least one trigger, and
b. multiple contingencies each with at least one trigger.

239. The financial instrument derived in accordance with said method of claim 238, wherein said establishing at least one trigger comprises setting said trigger at an amount equal to a multiple of a prevailing market rate for a financial instrument.

240. The financial instrument derived in accordance with said method of claim 239, wherein said setting said trigger equal to a multiple comprises using a multiple equal to 1.

241. The financial instrument derived in accordance with said method of claim 239, wherein said setting said trigger equal to a multiple comprises using a multiple less than 1.

242. The financial instrument derived in accordance with said method of claim 239, wherein said setting said trigger equal to a multiple comprises using a multiple greater than 1.

243. The financial instrument derived in accordance with said method of claim 238, wherein said establishing at least one trigger comprises setting said trigger equal to a multiple of a formula amount.

244. The financial instrument derived in accordance with said method of claim 243, wherein said setting said trigger equal to a multiple comprises using a multiple equal to 1.

245. The financial instrument derived in accordance with said method of claim 243, wherein said setting said trigger equal to a multiple comprises using a multiple less than 1.

246. The financial instrument derived in accordance with said method of claim 243, wherein said setting said trigger equal to a multiple comprises using a multiple greater than 1.

247. The financial instrument derived in accordance with said method of claim 231, wherein said attributing a number of said underlying references to said financial instrument comprises attributing a variable number of underlying references to each unit of said financial instrument.

248. The financial instrument derived in accordance with said method of claim 231, wherein said attributing a number of said underlying references to said financial instrument comprises attributing a constant number of underlying references to each unit of said financial instrument.

249. The financial instrument derived in accordance with said method of claim 231, wherein said identifying an underlying reference comprises identifying said underlying reference that said financial instrument converts into.

250. The financial instrument derived in accordance with said method of claim 231, wherein said identifying an underlying reference comprises basing an exchange value of said financial instrument on said underlying reference.

251. The financial instrument derived in accordance with said method of claim 231, wherein said interested party comprises a holder of said financial instrument.

252. A financial instrument derived in accordance with a method, said method comprising establishing a value for said financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

253. The financial instrument derived in accordance with said method of claim 252, wherein said establishing a value for said financial instrument comprises basing said value for said financial instrument on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

254. The financial instrument derived in accordance with said method of claim 252, wherein said interested party comprises a holder of said financial instrument.

255. A financial instrument derived in accordance with a method, said method comprising selling said financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

256. The financial instrument derived in accordance with said method of claim 255, wherein said selling said financial instrument comprises selling said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

257. The financial instrument derived in accordance with said method of claim 255, wherein said selling said financial instrument comprises auctioning said financial instrument.

258. The financial instrument derived in accordance with said method of claim 255, wherein said selling said financial instrument comprises selling a derivative of said financial instrument.

259. The financial instrument derived in accordance with said method of claim 255, wherein said selling said financial instrument comprises selling a part of said financial instrument.

260. The financial instrument derived in accordance with said method of claim 255, wherein said identifying an underlying reference comprises identifying said underlying reference that said financial instrument converts into.

261. The financial instrument derived in accordance with said method of claim 255, wherein said identifying an underlying reference comprises basing an exchange value of said financial instrument on said underlying reference.

262. The financial instrument derived in accordance with said method of claim 255, wherein said interested party comprises a holder of said financial instrument.

263. A financial instrument derived in accordance with a method, said method comprising buying said financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

264. The financial instrument derived in accordance with said method of claim 263, wherein said buying said financial instrument comprises buying said financial instrument at a value based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

265. The financial instrument derived in accordance with said method of claim 263, wherein said buying said financial instrument comprises bidding for said financial instrument.

266. The financial instrument derived in accordance with said method of claim 263, wherein said buying said financial instrument comprises buying a derivative of said financial instrument.

267. The financial instrument derived in accordance with said method of claim 263, wherein said buying said financial instrument comprises buying a part of said financial instrument.

268. The financial instrument derived in accordance with said method of claim 263, wherein said identifying an underlying reference comprises identifying said underlying reference that said financial instrument converts into.

269. The financial instrument derived in accordance with said method of claim 263, wherein said identifying an underlying reference comprises basing an exchange value of said financial instrument on said underlying reference.

270. The financial instrument derived in accordance with said method of claim 263, wherein said interested party comprises a holder of said financial instrument.

271. A financial instrument derived in accordance with a method, said method comprising selling said financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency;
establishing a value for said financial instrument.

272. The financial instrument derived in accordance with said method of claim 271, wherein said establishing a value for said financial instrument comprises establishing a value for said financial instrument based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

273. The financial instrument derived in accordance with said method of claim 271, wherein said selling said financial instrument comprises auctioning said financial instrument.

274. The financial instrument derived in accordance with said method of claim 271, wherein said selling said financial instrument comprises selling a derivative of said financial instrument.

275. The financial instrument derived in accordance with said method of claim 271, wherein said selling said financial instrument comprises selling a part of said financial instrument.

276. The financial instrument derived in accordance with said method of claim 271, wherein said identifying an underlying reference comprises identifying said underlying reference that said financial instrument converts into.

277. The financial instrument derived in accordance with said method of claim 271, wherein said identifying an underlying reference comprises basing an exchange value of said financial instrument on said underlying reference.

278. The financial instrument derived in accordance with said method of claim 271, wherein said interested party comprises a holder of said financial instrument.

279. A financial instrument derived in accordance with a method, said method comprising buying said financial instrument created by:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency;
establishing a value for said financial instrument.

280. The financial instrument derived in accordance with said method of claim 279, wherein said identifying an underlying reference comprises identifying said underlying reference that said financial instrument converts into.

281. The financial instrument derived in accordance with said method of claim 279, wherein said identifying an underlying reference comprises basing an exchange value of said financial instrument on said underlying reference.

282. The financial instrument derived in accordance with said method of claim 279, wherein said establishing a value for said financial instrument comprises establishing a value for said financial instrument based on at least one of:
a. said contingency;
b. said value of said underlying reference;
c. volatility in trading value of said underlying reference;
d. time until redemption, at option of issuer or holder;
e. time until maturity;
f. an interest rate; and
g. value for which said financial instrument must be redeemed for on redemption date.

283. The financial instrument derived in accordance with said method of claim 279, wherein said buying said financial instrument comprises bidding for said financial instrument.

284. The financial instrument derived in accordance with said method of claim 279, wherein said buying said financial instrument comprises buying a derivative of said financial instrument.

285. The financial instrument derived in accordance with said method of claim 279, wherein said buying said financial instrument comprises buying a part of said financial instrument.

286. The financial instrument derived in accordance with said method of claim 279, wherein said interested party comprises a holder of said financial instrument.

287. A financial instrument derived in accordance with a method, said method comprising monitoring for satisfaction of a contingency for a financial instrument created by:
identifying an underlying reference for said financial instrument, said underlying reference having a value;
attributing a number of said underlying references to said financial instrument;
defining said contingency, said financial instrument becoming convertible so that an interested party is given an option to convert said financial instrument on occurrence of said contingency.

288. The financial instrument derived in accordance with said method of claim 287, wherein said monitoring for satisfaction comprises comparing market data to requirements of said contingency.

289. The financial instrument derived in accordance with said method of claim 287, wherein said monitoring comprises monitoring at periodic intervals.

290. The financial instrument derived in accordance with said method of claim 287, wherein said monitoring comprises monitoring at predetermined times.

291. The financial instrument derived in accordance with said method of claim 287, wherein said monitoring comprises monitoring realtime data.

292. The financial instrument derived in accordance with said method of claim 287, wherein said method comprising monitoring further comprises processing a conversion on satisfaction of said contingency.

293. The financial instrument derived in accordance with said method of claim 287, wherein said identifying an underlying reference comprises identifying said underlying reference that said financial instrument converts into.

294. The financial instrument derived in accordance with said method of claim 287, wherein said identifying an underlying reference comprises basing an exchange value of said financial instrument on said underlying reference.

295. The financial instrument derived in accordance with said method of claim 287, wherein said interested party comprises a holder of said financial instrument.

296. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining a contingency, said financial instrument becoming convertible so that an interested party is given an option to convert said financial instrument on occurrence of said contingency.

297. The machine-readable data storage medium of claim 296, wherein said method further comprises:
establishing a value for said financial instrument.

298. The machine-readable data storage medium of claim 297, wherein said method further comprises:
selling said financial instrument.

299. The machine-readable data storage medium of claim 298, wherein said method further comprises:
monitoring for satisfaction of said contingency.

300. The machine-readable data storage medium of claim 297, wherein said method further comprises:
monitoring for satisfaction of said contingency.

301. The machine-readable data storage medium of claim 296, wherein said method further comprises:
selling said financial instrument.

302. The machine-readable data storage medium of claim 296, wherein said method further comprises:
monitoring for satisfaction of said contingency.

303. The machine-readable data storage medium of any one of claims 296, 297, 298, 299, 300, 301 and 302, said data storage medium being magnetic.

304. The magnetic machine-readable data storage medium of claim 303, said data storage medium being a floppy diskette.

305. The magnetic machine-readable data storage medium of claim 303, said data storage medium being a hard disk.

306. The machine-readable data storage medium of any one of claims 296, 297, 298, 299, 300, 301 and 302, said data storage medium being optically readable.

307. The optically readable storage medium of claim 306, said data storage medium being one of (a) a CD-ROM, (b) a CD-R, and (c) a CD-RW.

308. The optically readable data storage medium of claim 306, said data storage medium being a magneto-optical disk.

309. The machine-readable data storage medium of claim 306, wherein said interested party comprises a holder of said financial instrument.
